(19) United States
(12) Patent Application Publication
(10) Pub. No.: US 2010/0313246 A1
(43) Pub. Date: Dec. 9, 2010

(54) DISTRIBUTED PROTOCOL FOR AUTHORISATION

(75) Inventors: James Irvine, Glasgow (GB); Alisdair McDiarmuid, Glasgow (GB)

Correspondence Address: PEPPER HAMILTON LLP, ONE MELLON CENTER, 50TH FLOOR, 500 GRANT STREET, PITTSBURGH, PA, 15219, US

(73) Assignee: ITI SCOTLAND LIMITED, Glasgow (GB)

(21) Appl. No.: 12/680,151

(22) PCT Filed: Oct. 2, 2008
(86) PCT No.: PCT/GB2008/003324

§ 371 Date: Jul. 12, 2010

(30) Foreign Application Priority Data
Oct. 5, 2007 (GB) 0719583.7

(51) Int. Cl. G06F 21/00

(52) U.S. Cl. 726/4

(57) ABSTRACT

A decentralised, distributed approach to performing authorisation involves receiving an authorisation request at a service providing device, for example “Carol”, and then retrieving trust information from other peer devices in the network. The gathered information is used by the device “Carol” to make a well-informed authorisation decision.

### FIELD OF THE INVENTION

The invention relates to a distributed protocol for authorisation, and in particular to a recursive distributed protocol for peer-to-peer authorisation in a wireless communications network such as an Ultra Wideband communications network.

### BACKGROUND TO THE INVENTION

Ultra-wideband is a radio technology that transmits digital data across a very wide frequency range, 3.1 to 10.6 GHz. By spreading the RF energy across a large bandwidth the transmitted signal is virtually undetectable by traditional frequency selective RF technologies. However, the low transmission power limits the communication distances to typically less than 10 to 15 meters.

There are two approaches to UWB: the time-domain approach, which constructs a signal from pulse waveforms with UWB properties, and a frequency-domain modulation approach using conventional FFT-based Orthogonal Frequency Division Multiplexing (OFDM) over Multiple (frequency) Bands, giving MB-OFDM. Both UWB approaches give rise to spectral components covering a very wide bandwidth in the frequency spectrum, hence the term ultra-wideband, whereby the bandwidth occupies more than 20 percent of the centre frequency, typically at least 500 MHz.

These properties of ultra-wideband, coupled with the very wide bandwidth, mean that UWB is an ideal technology for providing high-speed wireless communication in the home or office environment, whereby the communicating devices are within a range of 10-15 m of one another.

FIG. 1 shows the arrangement of frequency bands in a Multi Band Orthogonal Frequency Division Multiplexing (MB-OFDM) system for ultra-wideband communication. The MB-OFDM system comprises fourteen sub-bands of 528 MHz each, and uses frequency hopping every 312.5 ns between sub-bands as an access method. Within each sub-band OFDM and QPSK or DCM coding is employed to transmit data. It is noted that the sub-band around 5 GHz, currently 5.1-5.8 GHz, is left blank to avoid interference with existing narrowband systems, for example 802.11a WLAN systems, security agency communication systems, or the aviation industry.

The fourteen sub-bands are organised into five band groups, four having three 528 MHz sub-bands, and one band group having two 528 MHz sub-bands. As shown in FIG. 1, the first band group comprises sub-band 1, sub-band 2 and sub-band 3. An example UWB system will employ frequency hopping between sub-bands of a band group, such that a first data symbol is transmitted in a first 312.5 ns duration time interval in a first frequency sub-band of a band group, a second data symbol is transmitted in a second 312.5 ns duration time interval in a second frequency sub-band of a band group, and a third data symbol is transmitted in a third 312.5 ns duration time interval in a third frequency sub-band of the band group. Therefore, during each time interval a data symbol is transmitted in a respective sub-band having a bandwidth of 528 MHz, for example sub-band 2 having a 528 MHz baseband signal centred at 3960 MHz.

A sequence of three frequencies on which each data symbol is sent represents a Time Frequency Code (TFC) channel. A first TFC channel can follow the sequence 1, 2, 3, 1, 2, 3 where 1 is the first sub-band, 2 is the second sub-band and 3 is the third sub-band. Second and third TFC channels can follow the sequences 1, 3, 2, 1, 3, 2 and 1, 1, 2, 2, 3, 3 respectively. In accordance with the ECMA-368 specification, seven TFC channels are defined for each of the first four band groups, with two TFC channels being defined for the fifth band group.

The technical properties of ultra-wideband mean that it is being deployed for applications in the field of data communications. For example, a wide variety of applications exist that focus on cable replacement in the following environments:
communication between PCs and peripherals, i.e. external devices such as hard disc drives, CD writers, printers, scanner, etc.
home entertainment, such as televisions and devices that connect by wireless means, wireless speakers, etc.
communication between handheld devices and PCs, for example mobile phones and PDAs, digital cameras and MP3 players, etc.

In wireless networks such as UWB networks one or more devices periodically transmit a Beacon frame during a Beacon Period. The main purpose of the Beacon frame is to provide for a timing structure on the medium, i.e. the division of time into so-called superframes, and to allow the devices of the network to synchronize with their neighbouring devices.

The basic timing structure of a UWB system is a superframe as shown in FIG. 2. A superframe according to the European Computer Manufacturers Association standard (ECMA), ECMA-368 2^{nd} Edition, consists of 256 medium access slots (MAS), where each MAS has a defined duration e.g. 256 μs. Each superframe starts with a Beacon Period, which lasts one or more contiguous MAS's. Each MAS forming the Beacon Period comprises three Beacon slots, with devices transmitting their respective Beacon frames in a Beacon slot. The start of the first MAS in the Beacon Period is known as the Beacon Period Start Time (BPST). A Beacon group for a particular device is defined as the group of devices that have a shared Beacon Period Start Time (±1 μs) with the particular device, and which are in transmission range of the particular device.

Wireless systems such as the UWB system described above are increasingly being used in an ad-hoc peer-to-peer configuration. This means that the network will exist without central control or organisation, with each device potentially communicating with all others within range. There are several advantages to this approach, such as spontaneity and flexible interactions. However, such a flexible arrangement also raises other problems which need to be solved.

In contrast with traditional academic, commercial, and industrial networking scenarios, smaller-scale networks are likely to grow piecemeal, and often include visiting devices from friends or business contacts. This unplanned approach is not well catered-for by traditional network security paradigms.

One key security problem in an unplanned network is authorisation. Authorisation is the decision making process which allows or disallows access to a network, device, or service. Traditionally, this decision is handled or enabled centrally, with an AAA (authentication, authorisation, accounting) server either making the decision or providing all information necessary to do so. In a spontaneously-grown network, or one in which device presence is highly dynamic, this is inappropriate. This is because no device can necessarily be relied upon to act as this server, and it may not have all the information necessary to be of use.

A paper by Clifford Neuman and Theodore Kerberos entitled “An Authentication Service for Computer Networks”, IEEE Communications, 32(9) pp 33-38, September 1994, describes an authentication protocol which, in version 5, can also be used for authorisation. This allows many service-providing devices to contact a single trusted authentication server to determine whether or not to allow access to a service. However, the protocol requires a single trusted central server, and therefore does not meet the needs of ad-hoc networks as described above.

It is therefore an aim of the present invention to provide an authorisation method and apparatus that can be used in an ad-hoc network.

### SUMMARY OF THE INVENTION

According to a first aspect of the invention, there is provided a method of performing authorisation between a first device and a second device in a wireless communications network. The method comprises the steps of: sending a request for authorisation from the first device to the second device; sending a query message from the second device to at least one third device; returning a response message from the at least one third device to the second device; wherein the response message contains authorisation data for use by the second device in determining whether to authorise the first device.

The invention defined in the claims takes a novel decentralised, distributed approach to the authorisation problem. Detailed authorisation information can be retrieved from the entire reachable network, gathered by the device controlling access to the network, device, or service. This information is then used by the access controlling device to make a well-informed authorisation decision.

The invention also has the advantage of providing the ability to pair a new wireless device once, then use distributed authorisation to set up a secure association with any other device in the network.

According to a further aspect of the present invention, there is provided a wireless network comprising: a first device adapted to send a request for authorisation to a second device; said second device being adapted to send a query message to at least one third device; wherein the second device is further adapted to determine whether to authorize the first device using authorisation data sent to the second device by one or more of the third devices in response to receiving the query message.

According to a further aspect of the invention, there is provided a device for use in a wireless network, the device being adapted to: transmit a query message to at least one other device in the network in response to receiving a request for authorization from an unauthorised device that is not yet authorised for use in the network; and determine whether to authorise the unauthorised device using authorisation data received from one or more of the at least one other device.

### BRIEF DESCRIPTION OF THE DRAWINGS

For a better understanding of the present invention, and to show more clearly how it may be put into effect, reference will now be made, by way of example only, to the following drawings, in which:

FIG. 1 shows the arrangement of frequency bands in a Multi-Band Orthogonal Frequency Division Multiplexing (MB-OFDM) system for ultra-wideband communication;

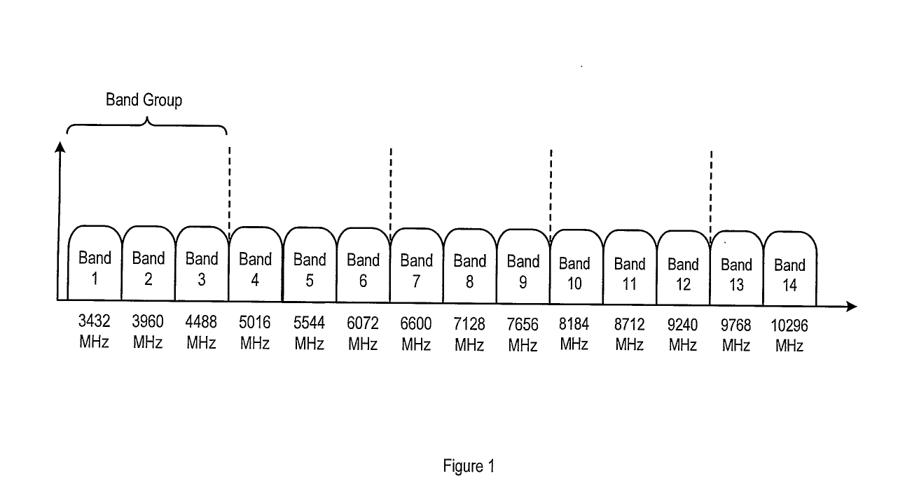

FIG. 2 shows the basic timing structure of a superframe in a UWB system;

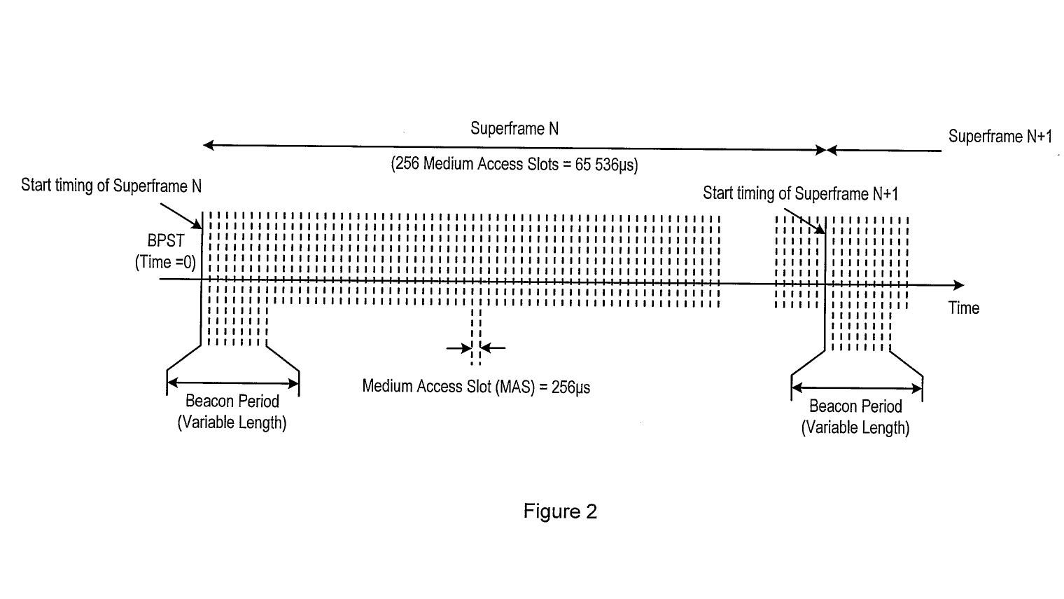

FIG. 3 shows a distributed authorisation protocol according to an embodiment of the present invention.

### DETAILED DESCRIPTION OF A PREFERRED EMBODIMENT OF THE INVENTION

The invention will be described in relation to a UWB wireless network. However, it will be appreciated that the invention is equally applicable to any wireless network in which distributed authorisation is performed.

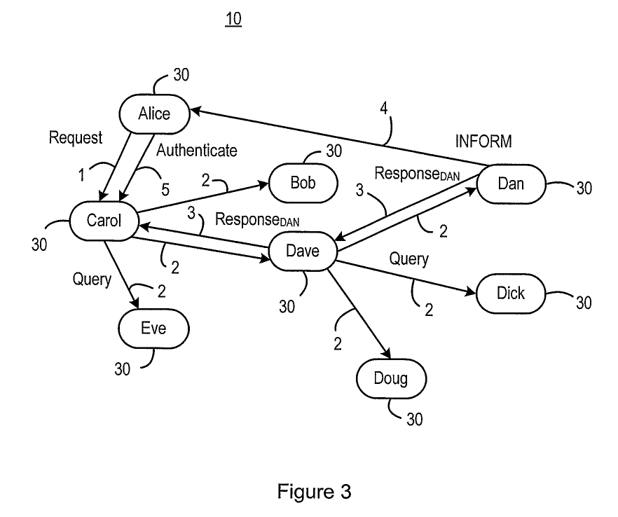

FIG. 3 shows a wireless network 10 having multiple wireless devices 30. For illustration purposes the wireless devices 30 are identified in this example by their user names. For example, the wireless network 10 in FIG. 3 has wireless devices 30 labelled Alice, Carol, Bob, Dave, Eve, Dan, Dick and Doug. As will be explained below, the protocol for performing distributed authorisation comprises multiple stages, with some of these stages in turn having multiple steps.

In the example of FIG. 3, the method for performing distributed authorisation comprises five main steps, with steps 2 and 3 having multiple messages.

In step 1 an unauthorised user, for example Alice, requests access to a network, device, or service which is controlled by a service-providing device, for example Carol. Access is requested by sending a request message 1. In the description below, the unauthorised device, Alice, will also be referred to as a “first device”, while the service-providing device, Carol; will also be referred to as a “second device”. In step 2 Carol sends a query message 2 to one or more of her logical peers, in this case Eve, Dave and Bob (which are neighbouring devices to Carol). The query message 2 includes an identification of the unauthorised user (i.e. Alice).

In the example provided in the embodiment of FIG. 3, Carol sends a query message 2 to each of the peer devices Eve, Dave and Bob, which will also be referred to hereinafter as “third devices”. The second device, Carol, can set a count value “N” in the query message relating to how many times or “hops” the query message 2 should be forwarded by the peer devices Eve, Dave and Bob to their respective neighbouring peer devices. In other words, the count value N determines how many times the query message 2 should be forwarded on a particular chain from one peer device to a “lower level” peer device (i.e. in terms of its position in the chain), for example from Dave to Dan, from Dan to Dan's peer (not shown) and so on. The count value N therefore determines how “deep” the query message is passed through the ad hoc network to seek authorisation for the service requesting device.

Upon receiving a query message 2, a peer device, for example Eve, Dave or Bob responds to the query message 2 if it has an assertion to make about the first device, i.e. Alice. In addition, the peer device forwards the query message 2 to its respective peers if the received count value is a suitable value. For example, if the count value is zero, the peer device does not forward the query message 2 to any of its peers. If the count value is equal or greater than 1, the peer device decrements the count value, and forwards the query message 2 (with the decremented count value attached or included) to one or more of its peer devices. It will be appreciated that the decision regarding whether or not to forward a query message 2 to lower level peer devices can be made on other count values, i.e. different to the “zero” decision described above.

It is noted that the count value N may be set in advance for a particular system or network. Alternatively, the count value N can be set according to the type of device making a particular request for service. It will be appreciated that other criteria for setting the count value N are also embraced by the present invention.

In FIG. 3 only the peer devices for wireless device Dave are shown for simplicity, but it will be appreciated that wireless devices Eve and Bob may also have respective peer devices. In the description hereinafter, a peer device such as Dan, i.e. a peer device of a third device will be referred to as a “fourth” device.

Peer devices who can respond to forwarded query messages 2, i.e. they have an assertion to make about the first device Alice, send their response message 3 back through the same path on the network. For simplicity, in FIG. 3 wireless device Dan is shown sending a response message 3 (Response_{DAN}) to Carol. The response message Response_{DAN} is forwarded to Carol via the peer device Dave. It will be appreciated that other devices, for example Bob, Eve, Dick or Doug may also send their respective response messages if they have an assertion to make about the first device, Alice.

Each link for transferring query messages 2 and response messages 3 is preferably secure, for example using data encryption in the data transmission between wireless devices. Thus, each peer device on the path preferably decrypts and re-encrypts a query message 2 as it is forwarded. At the same time, the relationship to the peer device for whom it is forwarding the query message is included in a “device attestation” part of the message. For example, in response to receiving a query message 2 from wireless device Carol, the wireless device Dave decrypts the query message 2, includes the relationship between Dave and Carol in a device attestation part of the query message 2, and encrypts the query message 2 before forwarding the query message 2 on to its peer devices Dan, Dick and Doug.

According to a further aspect of the present invention, in addition to a peer device sending a response message 3 to or towards Carol, the peer device may also send an “inform message” 4 to the unauthorised device making the original request for authorisation, i.e. Alice. For simplicity, in FIG. 3 wireless device Dan is shown sending an inform message 4 to Alice. It will be appreciated, however, that other devices sending a response message 3 to Carol may also send an inform message 4 to Alice.

The inform message 4 may contain authentication data for use by the unauthorised device (i.e. first device) Alice in authenticating with Carol. Further details about this aspect of the present invention can be found in a co-pending application entitled “Authentication Method and Framework” (UWB0031) by the present applicant. According to this further aspect of the present invention, the authenticating device Carol is able to compare authentication data received from Alice (which was in turn received from Dan in the inform message 4) with authentication data received from Dan in the response message 3. This allows the combination of authorisation and authentication to be carried out in one protocol flow.

A response message 3 from a peer device in the authorisation protocol, i.e. from any of the third devices, fourth devices, etc., includes zero or more binary assertions about the unauthorised device, i.e. the first device Alice. Associated with each of these predetermined assertions are first and second trust score values, which can be used by the service-providing device, i.e. the second device Carol, to calculate an overall score for the response.

Table 1 below shows an example of assertions and their corresponding first and second trust values.

TABLE 1

| Assertion | T(true) | T(false) |
|---|---|---|
| C: Is co-owned | 3 | 0 |
| P: Has paired | 2 | 0 |
| T: Has used this service | 2 | 0 |
| A: Has used a service | 1 | 0 |
| S: Should not be trusted | −1 | 1 |

In the example above, assertion type “C” indicates whether the unauthorised device is a co-owned device, i.e. whereby the first device and the peer device making the assertion have a common owner, and, if so, the assertion is allocated with a first trust value (True) of three, and if not, the assertion is allocated a second trust value (False) of zero.

Assertion type “P” indicates whether the first device is paired with the peer device making the assertion, and, if so, is allocated a first trust value (True) of two, and if not, a second trust value (False) of zero.

Assertion type “T” indicates whether the peer device is aware that the first device has previously used this service, and, if so, is therefore allocated a first trust value (True) of two, and if not, a second trust value (False) of zero. For example, a first device is deemed to have “used this service” if the service being requested by Alice from Carol has previously been used between Alice and Dan.

Assertion type “A” indicates whether the peer device is aware that the first device has used a service, and, if so, is therefore allocated a first trust value (True) of one, and a second trust value (False) of zero. For example, a first device is deemed to have “used a service” if the peer device Dan has previously provided some form of service to Alice, but different to the service currently being requested by Alice from Carol.

Assertion type “S” indicates whether the peer device considers that the first device should not be trusted, and, if this is the case, it is allocated a first trust value (True) of minus one, and if not, a second trust value (False) of one.

These assertions can be combined by the second device, i.e. Carol, in a predetermined manner to give a trust score for each response. For example, the trust scores for the first four assertions C, P, T and A can be combined together, and the total multiplied by the trust score for the last assertion S. This gives a positive or negative score, with weight relative to the amount of trust placed in the unauthorised device by the responding peer device. It is noted, for example, that the step of combining trust score values may comprise the step of adding together the trust score values for the various assertion types. Alternatively, the step of combining trust score values may comprise the step of multiplying trust score values for the various assertion types.

It will be appreciated that the invention can be used with any number of predetermined assertions, with different sets of assertion types, and with different weight values, i.e. trust score values, to those shown in Table 1. Furthermore, the invention is intended to embrace other methods of determining a trust score based on data received from a peer device.

According to one embodiment the service-providing device Carol may make an authorisation decision based on just one trust score derived from data received from just one peer device. For example, if a response message 3 sent from peer device Dave shows that unauthorised device Alice is co-owned by peer device Dave (i.e. assertion type “C” has a first trust value (True) of three), then this may be sufficient to allow device Carol to make a valid authorisation decision.

According to an alternative embodiment, the service-providing device Carol may require two or more trust scores in order to make a decision. In other words, several of these recommendation trust scores may be received by the service-providing device Carol before the final authorisation decision takes place, and a method for combining them appropriately is described as part of the invention.

The device metadata, contained within the forwarded response messages 3 or gathered from the link layer, is used to determine how much each recommendation is trusted. These can then be weighted according to a formula, and summed to give a total score at any given time.

The resultant score may be compared against some required threshold or target score by the service-providing device Carol. If, after some or all responses are received, the resultant score meets or exceeds the target score, the unauthorised device can be authorised, and the service provided. It is noted that the threshold level or target score can be selectively changed depending upon how many response messages are, or can be, received. For example, a first threshold level could be used when making the authorisation decision based on a response message from just one peer device, whereas a second threshold level could be used when making the authorisation decision based on response messages received from two or more peer devices.

Furthermore, as mentioned above, as part of the protocol, the service-providing device may also have received one or more authentication messages from the service-requesting device, which can also be used to set up a secure pairing between the two devices.

It will be appreciated that the invention described above comprises a protocol for retrieving authorisation information from devices present in a network; an authorisation information ontology to ensure that the devices can understand each other's information; and a score-based decision-making process to handle this information.

The distributed authorisation can be used for multiple purposes. One traditional use is for controlling access to services, such as printer sharing or file transfer. Another is replacing the normal password or shared-key approach to network access. The invention is also very useful in a slowly-growing network, since it provides the possibility of using the authorisation protocol to allow devices to perform secure pairing without requiring any manual authentication procedure.

The invention allows any service-providing device to gather detailed information from its network peers, which can then be used to make a complex authorisation decision. All of this can be achieved with no direct user interaction and no dedicated authentication server.

The protocol for retrieving authorisation information enables multi-level queries, which allow a service-providing device in a loosely-connected mesh network to query more than just its immediate peers. The level to which queries should be forwarded is controllable, to avoid excessive network utilisation. In other words, the device controlling the authorisation, i.e. Carol, will hold a count value which indicates the level to which query messages should be forwarded.

The invention has the advantage of not requiring any central authentication server, as the protocol can perform authentication as well as authorisation. In addition, the authorisation decision is more effective due to the extra information retrieved from network devices. The authorisation is based upon trust levels derived from the past experiences of other devices, rather than pre-defined and arbitrary privileges.

This enables a new approach to authorisation which will more accurately assess devices for acceptance, and dynamically adapt to abuse without explicit user intervention to update the privilege table.

New devices can be paired once, and then progressively gather more secure associations to other networked devices using the invention. This requires vastly reduced effort from the device owner. The invention therefore requires minimal setup and user interaction, making this a highly usable approach to securing networks, devices, and services. The invention also enables secured services with complex authorisation requirements for ad-hoc network situations, such as business meetings and conferences.

Although the preferred embodiment is described as having first and second trust score values for each assertion type, it will be appreciated that one or more of the assertion types may have just one trust score value.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of performing authorisation between a first device and a second device in a wireless communications network, the method comprising the steps of:
sending a request for authorisation from the first device to the second device;
sending a first query message from the second device to at least one third device;
returning a first response message from the at least one third device to the second device;
wherein the first response message contains first authorisation data for use by the second device in determining whether to authorise the first device.

2. A method as claimed in claim 1, further comprising the steps of:
forwarding a second query message from a third device to a fourth device;
returning a second response message from the fourth device to the second device;
wherein the second response message from the fourth device contains second authorisation data for use by the second device in determining whether to authorise the first device.

3. A method as claimed in claim 2, wherein the second response message is returned from the fourth device to the second device via the third device.

4. A method as claimed in claim 1, wherein the first authorisation data comprises one or more predetermined assertions relating to the first device.

5. A method as claimed in claim 4, wherein a predetermined assertion relates to historical data between a device and the first device.

6. A method as claimed in claim 4, wherein a predetermined assertion comprises at least one trust value.

7. A method as claimed in claim 4, wherein a predetermined assertion comprises a first trust value and a second trust value.

8. A method as claimed in claim 6, further comprising the steps of:
determining a trust score at the second device based on one or more trust values received in one or more response messages; and
performing an authorisation decision at the second device using the determined trust score.

9. A method as claimed in claim 8, wherein the authorisation decision comprises the step of comparing the trust score with a threshold value, and authorising the first device if the trust score is higher than, or equal to, the threshold value.

10. A method as claimed in claim 1, further comprising the steps of:
including authentication data in a second response message sent from a device to the second device;
sending corresponding authentication data from said device to the first device; and
using the authentication data at the second device to perform authentication between the first device and the second device.

11. A method as claimed in claim 1, further comprising the step of transmitting messages between devices in a secure manner.

12. A method as claimed in claim 11, wherein the step of transmitting messages in a secure manner comprises the step of encrypting transmitted data and decrypting received data.

13. A method as claimed in claim 1, further comprising the step of providing a count value in a query message, wherein the count value is used to control whether a query message is forwarded from a particular device to another device.

14. A wireless network comprising:
a first device adapted to send a request for authorisation to a second device;
said second device being adapted to send a query message to at least one third device;
wherein the second device is further adapted to determine whether to authorise the first device using authorisation data sent to the second device by one or more of the third devices in response to receiving the query message.

15. A wireless network as claimed in claim 14, wherein a third device is adapted to forward the query message received from the second device to a fourth device, and wherein the fourth device is adapted to return a response message to the second device, the response message comprising authorisation data for use by the second device in determining whether to authorise the first device.

16. A wireless network as claimed in claim 15, wherein the fourth device is adapted to return the response message to the second device via the third device.

17. A wireless network as claimed in claim 14, wherein the authorisation data comprises one or more predetermined assertions relating to the first device.

18. A wireless network as claimed in claim 17, wherein a predetermined assertion relates to historical data between a device and the first device.

19. A wireless network as claimed in claim 17, wherein a predetermined assertion comprises at least one trust value.

20. A wireless network as claimed in claim 17, wherein a predetermined assertion comprises a first trust value and a second trust value.

21. A wireless network as claimed in claim 19, wherein the second device is further adapted to:
determine a trust score based on one or more trust values received in one or more response messages; and
perform an authorisation decision using the determined trust score.

22. A wireless network as claimed in claim 21, wherein the second device is adapted to compare the determined trust score with a threshold value, and authorise the first device if the trust score is higher than, or equal to, the threshold value.

23. A wireless network as claimed in claim 14, wherein the network is further adapted to:
transmit authentication data in a second response message sent from a device to the second device:
send corresponding authentication data from said device to the first device; and
use the authentication data at the second device to perform authentication between the first device and the second device.

24. A wireless network as claimed in claim 14, wherein the network is adapted to transmit messages between devices in a secure manner.

25. A wireless network as claimed in claim 24, wherein a device is adapted to encrypt transmitted data and decrypt received data.

26. A wireless network as claimed in claim 14, wherein a device is adapted to:
check a count value in a received message;
determine if the count value is equal to a predetermined value and, if not, decrement the count value and forward the received message to another connected device.

27. A device for use in a wireless network, the device being adapted to:
transmit a query message to at least one other device in the network in response to receiving a request for authorization from an unauthorised device that is not yet authorised for use in the network; and
determine whether to authorise the unauthorised device using authorisation data received from one or more of the at least one other device.
